(19) United States
(12) Patent Application Publication
(10) Pub. No.: US 2011/0311789 A1
(43) Pub. Date: Dec. 22, 2011

(54) Methods for Attaching Flexible Substrates to Rigid Carriers and Resulting Devices

(75) Inventors: Douglas E. Loy, Chandler, AZ (US); Shawn M. O'Rourke, Tempe, AZ (US)

(73) Assignee: Arizona Board of Regents, A Body Corporate Acting for and on behalf of Arizona State University, Scottsdale, AZ (US)

(21) Appl. No.: 13/062,020

(22) PCT Filed: Sep. 10, 2009
(86) PCT No.: PCT/US2009/056501

§ 371 Date: Aug. 30, 2011

Related U.S. Application Data
(60) Provisional application No. 61/096,530, filed on Sep. 12, 2008.

(51) Int. Cl. B23K 31/02; B32B 3/22

(52) U.S. Cl. 428/198; 228/180.1; 228/122.1

(57) ABSTRACT

Flexible substrates can be temporarily attached to a rigid carrier for processing a surface thereof by depositing a joining material at one or more contact points between a flexible substrate and a rigid carrier, contacting the flexible substrate and the rigid carrier at the one or more contact points; and exposing the one or more contact points to a temperature of between 219° C. and 1000° C. and under conditions suitable for attaching the flexible substrate and the rigid carrier at the one or more contact points via the joining material. Examples of suitable joining materials include, but are not limited to soldering or brazing materials. Such supported substrates can be used for preparing flexible displays comprising at least one electronic component and/or circuit on a surface of the flexible display.

### CROSS-REFERENCE TO RELATED APPLICATION

This application claims the benefit of the filing date of U.S. Provisional Application Ser. No. 61/096,530, filed Sep. 12, 2008, which is hereby incorporated by reference in its entirety.

### STATEMENT OF GOVERNMENT INTEREST

This application was supported in part by funding from the Army Research Lab under grant # W911NF-04-2-0005. The U.S. government has certain rights in the invention.

### BACKGROUND OF THE INVENTION

Material systems that permit temporary bonding of flexible substrates (ex. stainless steel, polyethylene naphtalate, polyimide or similar) that will not compromise handling or performance of the substrates will facilitate the rapidly expanding demand for flexible electronics. For example, in a process of fabricating thin film transistors or thin film transistor circuits on a substrate, a large number of process steps are performed during which the substrate may be moved through several machines, ovens, cleaning steps, etc. To move a flexible substrate through such a process, the flexible substrate must be temporarily mounted in some type of carrier or a rigid carrier must be removably attached, so that the flexible carrier can be moved between process steps. Development of such a materials system would allow existing fabrications (i.e. Semiconductor, active matrix TFT or PV) to use the current installed base of tools for manufacturing as flexible transistor (or other) technology continues to mature and the market grows (83.5% per year, iSuppli). Typical examples of such products or structures derived from flexible substrates are active matrices on flat panel displays, RFID tags on various commercial products in retail stores, a variety of sensors, etc.

Unfortunately, most flexible substrates are too thin to be handled freestanding in standard microelectronic/semiconductor tools. While some progress has been made in the use of organic systems (i.e. adhesives), these materials greatly prohibit the maximum processing temperature of the system. This can create deleterious effects in many semiconductor processes including amorphous silicon, low temperature (450° C.) polysilicon, and inorganic solar cells (CIGS, CdTe, etc.)

### SUMMARY OF THE INVENTION

In one aspect, the invention provides methods for attaching a flexible substrate to a rigid carrier, comprising (a) depositing a joining material at one or more contact points between a flexible substrate and a rigid carrier; (b) contacting the flexible substrate and the rigid carrier at the one or more contact points; and (c) exposing the one or more contact points to a temperature of between 219° C. and 1000° C. and under conditions suitable for attaching the flexible substrate and the rigid carrier at the one or more contact points via the joining material.

In another aspect, the invention provides assemblies comprising (a) a flexible substrate; (b) a rigid carrier; and (c) a plurality of discrete contact points between the flexible substrate and the rigid carrier, wherein the contact points comprise a joining material with a melting temperature between 219° C. and 1000° C., and wherein the flexible substrate and the rigid carrier have a melting temperature greater that the melting temperature of the joining material.

In yet another aspect, the invention provides assemblies comprising (a) a flexible substrate; (b) a rigid carrier; and (c) a joining material at one or more contact points between the flexible substrate and the rigid carrier, wherein the joining material has a melting temperature between 219° C. and 1000° C., and wherein the flexible substrate and the rigid carrier have a melting temperature greater that the melting temperature of the joining material, and wherein the assembly has a bow of less than 150 μm.

In still another aspect, the invention provides methods for attaching a plastic flexible substrate to a rigid carrier, comprising (a) depositing a joining material on a surface of the rigid carrier at one or more contact points between the plastic flexible substrate and a rigid carrier; (b) aligning a metalized surface of a plastic flexible substrate and the joining material on the surface of the rigid carrier surface, wherein the metallization is present on a surface of the flexible substrate at the one or more contact points; (c) contacting the plastic flexible substrate and the rigid carrier at the one or more contact points; and (d) exposing the one or more contact points to a temperature of between 219° C. and 1000° C. and under conditions suitable for attaching the plastic flexible substrate and the rigid carrier at the one or more contact points via the joining material.

### DETAILED DESCRIPTION OF THE INVENTION

In a first aspect, the present invention provides methods for attaching flexible substrates to a rigid carrier, comprising
(a) depositing a joining material at one or more contact points between a flexible substrate and a rigid carrier;
(b) contacting the flexible substrate and the rigid carrier at the one or more contact points; and
(c) exposing the one or more contact points to a temperature of between 219° C. and 1000° C. and under conditions suitable for attaching the flexible substrate and the rigid carrier at the one or more contact points via the joining material.

The methods and devices of the present invention enable the effective handling of flexible substrates in standard microelectronic/semiconductor manufacturing tools under a wide range of processing temperatures. The approach detailed herein mitigates the potential contamination or failure of an adhesive when exposed to relatively harsh microelectronic processing environments. The methods and devices provide the following additional benefits over prior methods and devices involving adhesive bonding, particularly at processing temperatures above 219° C.:
Ability to bond a wide range of dissimilar surfaces.
Capability to withstand high temperatures, up to 1000° C.
Ability to tailor/engineer physical and mechanical properties of the bond interface
   Ductile strain relief to mitigate coefficient of thermal expansion mismatch
   Facilitate mechanical debond.
Corrosion resistance
Vacuum compatibility

The term “rigid carrier” as used herein for all aspects and embodiments of the invention means any material that is capable of withstanding the processing used to fabricate electronic components or circuits on a flexible substrate. In one preferred embodiment, the rigid carrier comprises a semiconducting material. In another preferred embodiment, the rigid carrier is a semiconductor wafer, such as a silicon wafer (preferably, with a flat surface). In further preferred embodiments, the rigid carrier may comprise or consist of a semiconductor substrate or glass; including but not limited to Si or Si(100). Any semiconductor substrate of the various aspects and embodiments of the invention may independently comprise Si, SiGe, Ge, SiGeSn, GeSn, GaAs, InP, and the like. Preferably, any semiconductor substrate of the various aspects and embodiments of the invention may independently comprise or consist of Si or Si(100). In another preferred embodiment of the various aspects and embodiments of the invention, the rigid carrier has at least one substantially flat surface.

The term “flat” as used herein means that each point on the surface is less than about 100 μm from a line defined by the center of the carrier. In a preferred embodiment, each point on the surface is less than about 75 μm from a line defined by the center of the carrier. In another preferred embodiment, each point on the surface is less than about 60 μm from a line defined by the center of the substrate. The carrier generally has a thickness of between 300 μm and 2000 μm; in other preferred embodiments, the thickness may be between 300 μm and 1500 μm, 300 μm and 1100 μm, 500 μm and 2000 μm, 500 μm and 1500 μm, and 500 μm and 1100 μm.

The carrier and the flexible substrate can be the same size or different sizes, such as a smaller flexible substrate arrayed on the carrier. There is no upper limit on the size of the carrier. The carrier can be monolithic or may comprise multiple layers.

The term “flexible substrate” as used herein for all aspects and embodiments of the invention means a free-standing substrate comprising a flexible material which readily adapts its shape. In various preferred embodiments, the flexible substrates comprise or consist of metal films including but not limited to FeNi alloys (e.g., INVAR™, FeNi, or FeNi36; INVAR™ is an alloy of iron (64%) and nickel (36%) (by weight) with some carbon and chromium), FeNiCo alloys (e.g., KOVAR™, KOVAR™ is typically composed of 29% nickel, 17% cobalt, 0.2% silicon, 0.3% manganese, and 53.5% iron (by weight)), titanium, tantalum, molybdenum, aluchrome, aluminum, and stainless steel (including but not limited to SS304 and SS430). In other preferred embodiments, the flexible substrates comprise or consist of polymeric sheets, including but not limited to polyimides, polyethylene, polycarbonates, polyethylene terephthalate (PET), polyethylene naphthalate (PEN), polyethersulfone (PES), cyclic olefin copolymer, and multi-layer stacks comprising two or more metal and/or polymeric materials provided the entire stack assembly remains flexible. In another preferred embodiment, the flexible substrate may be a flexible glass substrate, including but not limited to Corning 0211, thinned Eagle.

The flexible substrate may consist of only a single layer or may comprise multiple layers, for example to provide increased functionality. For example, a moisture barrier layer can be included on either or both sides of the flexible substrate to prevent moisture or oxygen absorption after detachment from the rigid carrier. Other functionalities can also be added to the flexible substrate, as will be understood by those of skill in the art based on the teachings herein.

The flexible substrates are preferably thin; ranging, from about 1 μm to 500 μm thick or 1 μm to 250 μm. In further preferred embodiments, the flexible substrate is about 10 μm to 250 μm, 10 μm to 200 μm, 10 to 150 μm, 25 μm to 500 μm, 25 μm to 250 μm, 25 μm to 200 μm, 25 μm to 150 μm, 50 μm to 500 μm, 50 μm to 250 μm, 50 ηm to 200 μm, or 50 μm to 150 μm thick.

As used herein, the “joining material” is any material that can be used to join the flexible substrate and the rigid carrier, where the joining material has a melting temperature of between 219° C. and 1000° C., for example between 225° C. and 1000° C., and where the flexible substrate and the rigid carrier have a melting temperature higher that the joining material. In non-limiting preferred embodiments, such joining materials comprise or consist of solders or brazing materials. Non-limiting examples of solders that meet these requirements include, but are not limited to Sn, SnAgCu alloys (such as SnAg(3.5-3.8)Cu(0.7-1)), SnCuSbAg alloys (such as SnCu2.0Sb0.8Ag0.2), and SnSb5 alloys, all of which have melting ranges of 219° C. to 240° C.

Non-limiting examples of brazing materials that meet these requirements include, but are not limited to Ni/Ag, Cu/Zn, Cu/Ag, and ZnAl alloys for metal to metal bonding, or reactive brazing (S-bond), which refers to a set of materials that includes Ti or other rare earth elements that “scrub” oxides from the material's surface, which greatly facilitates wetting and bonding. The use of solder results in little intermolecular bonding between the flexible substrate and the rigid carrier; thus, the solder absorbs and relaxes stress between the two and mitigates coefficient of thermal expansion (CTE) mismatch, through ductile flow (ie: ductile strain relief). This provides the ability to bond a wide range of dissimilar surfaces. The use of brazing materials as the joining material permits the formation of intermetallic bonding regions, which results in an assembly that is stronger at higher temperatures, but providing less ductile flow. Based on the teachings herein, those of skill in the art can determine an appropriate joining material for use in the methods of the invention.

In various aspects and embodiments of the invention, preferred methods comprise depositing the joining material at one or more contact points between a flexible substrate and a rigid carrier. Such deposition can be by any suitable technique, including but not limited to sputtering, evaporation, screen printing, and ink jet printing. The joining material may be deposited on a surface of the flexible substrate only, the rigid carrier only, or both.

When the flexible substrate is plastic, it is metalized at the one or more contact points with a bondable material (ie: one with sufficient wetting and adhesion) to allow for the high temperature joining afforded by the joining materials. Such bondable materials include, but are not limited to silver and aluminum. Such metallization can be carried out using any suitable technique, including but not limited to sputtering and evaporation.

As used herein, a “contact point” is an area on the flexible substrate or the rigid carrier on which the joining material is deposited; upon contacting of the flexible substrate and the rigid carrier and exposing the one or more contact points to the required temperature, bonding between the flexible substrate and the rigid carrier occur at the contact points via the joining material. The bond can be based, for example, on a chemical reaction between the substrates and the joining material.

There may be one or more such contact points. In one preferred embodiment, there is a single contact point, which is continuous along the perimeter (for example, between 5 μm and 5 mm from the edge) of the flexible substrate and the rigid carrier. In another preferred embodiment there are a plurality (ie: 2 or more) of discrete contact points (for example, partially continuous along the perimeter); in various preferred embodiments, there are at least 4, 8, 12, 16, 20, 24, 28, 32, or more contact points, or the contact point may be continuous between the flexible substrate and the rigid carrier. In these various preferred embodiments, it is preferred that the contact points are along a perimeter of the flexible substrate and the rigid carrier.

In a preferred embodiment of all of the embodiments herein, a thickness of the one or more contact points is between 2 μm and 100 μm; in various further preferred embodiments the thickness is between 2 μm and 75 μm; 2 μm and 50 μm; 5 μm and 100 μm; 5 μm and 75 μm; 2 μm and 50 μm; 10 μm and 100 μm; 10 μm and 75 μm; 10 μm and 50 μm; and 20 μm and 100 μm. In another preferred embodiment of all of the embodiments herein, a width of the one or more contact points is between 100 μm and 4 mm; in various further preferred embodiments the thickness is between 100 μm and 3 mm; 100 μm and 2 mm; 100 μm and 1 mm; 250 μm and 4 mm; 500 μm and 4 mm; and 1 mm and 4 mm.

For attachment, the flexible substrate and the rigid carrier are aligned and contacted at the one or more contact points; alignment may comprise any suitable technique, including but not limited to lithographic processing, shadow masking, and traditional photolithography and printing. Such contacting can be done using any force suitable for facilitating contact between the flexible substrate and the rigid carrier while providing uniform bonding with low total thickness variation from contact point to contact point. In one non-limiting preferred embodiment, force is applied in a vacuum bond chamber using a piston with a size larger than the substrates. In one embodiment, a force of between 5 and 40 kN is applied to the one or more contact points between the flexible substrate and the rigid carrier; such force application can be applied to the assembly as a whole, or be localized to the contact points as suitable for a given application. Force application can be initiated prior to exposing the contact points to high temperature, or can be initiated at the time of high temperature exposure.

The methods comprise exposing the one or more contact points to a temperature of between 219° C. and 1000° C., or between 225° C. and 1000° C., and under conditions suitable for attaching the flexible substrate and the rigid carrier at the one or more contact points via the joining material. Such conditions may include pressure application, which may occur in vacuum. The exact temperature used will depend on the joining material used and the material used for the flexible substrate and the rigid carrier; the temperature will be at or above the melting temperature of the joining material, but below the melting temperature of the flexible substrate and the rigid carrier. The high temperature exposure results in bonding while the joining material is molten and involves chemically bonding the flexible substrate and the rigid carrier with the joining material. Determination of appropriate temperatures for use in a given application can thus be determined by one of skill in the art based on the teachings herein. In various non-limiting examples, amorphous Si thin film transistor manufacturing is carried out at about 300° C.; low temperature polysilicon TFT manufacturing (for OLEDs) is carried out at 500° C. to 600° C.; and CIGS solar cell manufacture is carried out at 400° C. to 600° C. In various embodiments, the one or more contact points are exposed to temperatures between 250° C. and 1000° C.; 300° C. and 1000° C.; 350° C. and 1000° C.; 400° C. and 1000° C.; 450° C. and 1000° C.; 500° C. and 1000° C.; 550° C. and 1000° C.; 600° C. and 1000° C.; 350° C. and 750° C.; 400° C. and 750° C.; 450° C. and 750° C.; 500° C. and 750° C.; 350° C. and 600° C.; 400° C. and 600° C.; 450° C. and 600° C.; and 500° C. and 600° C. In general, ranges for solders would be between 219° C. and 450° C., or 225° C. and 450° C. and the range for blazing material would be between 450° C. and 1000° C.; as will be understood by those of skill in the art, brazing materials can be used at lower temperatures, and the use of ultrasonic energy can be employed to limit temperature exposure.

The heating may comprise uniformly heating the entire assembly (including, but not limited to, heating in a furnace), or may comprise heating only the contact points by, for example, application of ultrasonic or laser energy sources.

In one preferred embodiment of all of the embodiments of the methods herein, exposing the one or more contact points to a temperature of between 219° C. and 1000° C. is done under vacuum (e.g., less than about 1 Torr; preferably just less than 1 Torr).

After bonding is complete, the assembly can be cooled to an appropriate temperature, such as ambient temperature or any other suitable temperature for a given use.

Once the flexible substrate is bound to the rigid carrier, any desired microelectronic processing steps can be performed on the flexible substrate, including but not limited to fabricating one or more electronic components on a surface of the flexible substrate, forming one or more of thin film transistors, organic light emitting diodes, inorganic light emitting diodes, electrode arrays, field effect transistors, passive structures, photovoltaic structures, or combinations thereof on a surface of the flexible substrate, and forming a display architecture on the flexible substrate.

Once the desired microelectronic processing is complete, the flexible substrate can be detached from the rigid carrier using any suitable technique, such as the use of thermal energy (i.e., laser) and mechanical debonding, and subjected to any further processing steps. Use of the joining materials of the invention results in the contact points being substantially weaker than the flexible substrate and rigid carrier materials, facilitating the debonding process.

In a second aspect, the present invention provides an assembly, comprising
(a) a flexible substrate;
(b) a rigid carrier; and
(c) a plurality of discrete contact points between the flexible substrate and the rigid carrier,
wherein the contact points comprise a joining material with a melting temperature between 219° C. and 1000° C., and wherein the flexible substrate and the rigid carrier have a melting temperature greater that the melting temperature of the joining material.

In one preferred embodiment of the second aspect, the plurality of discrete contact points comprises at least 4, 8, 12, 16, 20, 24, 28, 32, 100, 500, 1000, 200, 300, 4000, or more contact points. In another preferred embodiment, the plurality of discrete contact points, comprises at least 4, 8, 12, 16, 20, 24, 28, 32, or more contact points. In these various preferred embodiments, it is preferred that the contact points are along a perimeter of the flexible substrate and the rigid carrier.

In a preferred embodiment of the second aspect, a thickness of the one or more contact points is between 2 μm and 100 μm; in various further preferred embodiments the thickness is between 2 μm and 75 μm; 2 μm and 50 μm; 5 μm and 100 μm; 5 μm and 75 μm; 2 μm and 50 μm; 10 μm and 100 μm; 10 μm and 75 μm; 10 μm and 50 μm; and 20 μm and 100 μm. In another preferred embodiment of the second aspect, a width of the one or more contact points is between 100 μm and 4 mm; in various further preferred embodiments the thickness is between 100 μm and 3 mm; 100 μm and 2 mm; 100 μm and 1 mm; 250 μm and 4 mm; 500 μm and 4 mm; and 1 mm and 4 mm.

In a preferred embodiment of the second aspect, the joining material has a melting temperature of between 219° C. and 1000° C., or between 225° C. and 1000° C., and where the flexible substrate and the rigid carrier have a melting temperature higher that the joining material. In non-limiting preferred embodiments, such joining materials comprise or consist of solders or brazing materials. Non-limiting examples of solders that meet these requirements include, but are not limited to Sn, SnAgCu alloys (such as SnAg(3.5-3.8)Cu(0.7-1)), SnCuSbAg alloys (such as SnCu2.0Sb0.8Ag0.2), and SnSb5 alloys, all of which have melting ranges of 219° C. to 240° C.

In another preferred embodiment of the second aspect, the joining material is a brazing materials that meet the preceding requirements including, but are not limited to Ni/Ag, Cu/Zn, Cu/Ag, and ZnAl alloys for metal to metal bonding, or reactive brazing (S-bond),

In a preferred embodiment of the second aspect, the joining material is selected from the group consisting of SnAgCu alloys, SnZn alloys, Ni/Ag alloys, Cu/Zn alloys, and Cu/Ag alloys.

In a preferred embodiment of the second aspect, the flexible substrate is a plastic substrate or metal substrate. Suitable plastic substrates include, but are not limited to polyethylene naphthalate (PEN), polyethylene terephthalate (PET), polyethersulfone (PES), polyimide, polycarbonate, cyclic olefin copolymer, or mixtures thereof. In another embodiment, the flexible substrate is a metal substrate, and the metal substrate comprises a material selected from the group consisting of INVAR™, KOVAR™, titanium, tantalum, molybdenum, aluchrome, aluminum, stainless steel, or mixtures thereof. The flexible substrate may consist of only a single layer or may comprise multiple layers, for example to provide increased functionality. For example, a moisture barrier layer can be included on either or both sides of the flexible substrate to prevent moisture or oxygen absorption after detachment from the rigid carrier. Other functionalities can also be added to the flexible substrate, as will be understood by those of skill in the art based on the teachings herein. The flexible substrates are preferably thin; ranging, from about 1 μm to 500 μm thick or 1 μm to 250 μm. In further preferred embodiments, the flexible substrate is about 10 μm to 250 μm, 10 μm to 200 μm, 10, 25 μm to 500 μm, 25 μm to 250 μm, 25 μm to 200 μm, 25 μm to 150 μm, 50 μm to 500 μm, 50 μm to 250 m, 50 μm to 200 μm, or 50 μm to 150 μm thick.

In one preferred embodiment of the second aspect, the rigid carrier comprises a semiconducting material. In another preferred embodiment, the rigid carrier is a semiconductor wafer, such as a silicon wafer (preferably, with a flat surface). In further preferred embodiments, the rigid carrier may comprise or consist of a semiconductor substrate or glass; including but not limited to Si or Si(100). Any semiconductor substrate of the various aspects and embodiments of the invention may independently comprise Si, SiGe, Ge, SiGeSn, GeSn, GaAs, InP, and the like. Preferably, any semiconductor substrate of the various aspects and embodiments of the invention may independently comprise or consist of Si or Si(100). In another preferred embodiment of the second aspect, the rigid carrier has at least one substantially flat surface.

In another preferred embodiment, the rigid support comprises a material including, but not limited to, semiconductor wafer (such as those comprising Si), alumina, a glass, or a material CTE matched to the flexible substrate.

In further preferred embodiments of the second aspect, a surface of the flexible substrate comprises one or more microelectronic features, including but not limited to thin film transistors, organic light emitting diodes, inorganic light emitting diodes, electrode arrays, field effect transistors, passive structures, or combinations thereof on a surface of the flexible substrate, and display architectures on the flexible substrate.

All embodiments of the first aspect of the invention are equally applicable to this second aspect of the invention.

In a third aspect, the present invention provides assemblies, comprising
(a) a flexible substrate;
(b) a rigid carrier; and
(c) a joining material at one or more contact points between the flexible substrate and the rigid carrier,
wherein the joining material has a melting temperature between 219° C. and 1000° C., or between 225° C. and 1000° C., and wherein the flexible substrate and the rigid carrier have a melting temperature greater that the melting temperature of the joining material, and wherein the assembly has a bow of less than 150 μm.

The term “bow” as used herein means the curvature of a substrate about a median plane. The relatively high coefficient of thermal expansion (CTE) for flexible substrates compared to inorganic silicon or glass substrates leads to significant CTE induced strain mismatch during temperature excursions including inorganic thin film transistor (TFT) processing. This phenomenon introduces significant bowing and can lead to handling errors, photolithographic alignment errors, and line/layer defects. The joining materials and methods of the present invention herein minimize bowing of the flexible substrate as a result of the thermal stresses and/or strains introduced during, for example, semiconductor manufacturing processes.

In various preferred embodiments, the bowing of a flexible substrate, when attached to a rigid support according to any of the preceding methods and embodiments, is less than about 150 μm, 125 μm, 100 μm, 75 μm, or 60 μm.

In a preferred embodiment of the third aspect, the joining material has a melting temperature of between 219° C. and 1000° C., or between 225° C. and 1000° C., and where the flexible substrate and the rigid carrier have a melting temperature higher that the joining material. In non-limiting preferred embodiments, such joining materials comprise or consist of solders or brazing materials. Non-limiting examples of solders that meet these requirements include, but are not limited to Sn, SnAgCu alloys (such as SnAg(3.5-3.8)Cu(0.7-1)), SnCuSbAg alloys (such as SnCu2.0Sb0.8Ag0.2), and SnSb5 alloys, all of which have melting ranges of 219° C. to 240° C.

In another preferred embodiment of the third aspect, the joining material is a brazing materials that meet the preceding requirements including, but are not limited to Ni/Ag, Cu/Zn, Cu/Ag, and ZnAl alloys for metal to metal bonding, or reactive brazing (S-bond),

In a preferred embodiment of the third aspect, the joining material is selected from the group consisting of SnAgCu alloys, SnZn alloys, Ni/Ag alloys, Cu/Zn alloys, and Cu/Ag alloys.

In one preferred embodiment of the third aspect, the plurality of discrete contact points comprises at least 4, 8, 12, 16, 20, 24, 28, 32, 100, 500, 1000, 200, 300, 4000, or more contact points. In another preferred embodiment, the plurality of discrete contact points, comprises at least 4, 8, 12, 16, 20, 24, 28, 32, or more contact points. In these various preferred embodiments, it is preferred that the contact points are along a perimeter of the flexible substrate and the rigid carrier.

In a preferred embodiment of the third aspect, a thickness of the one or more contact points is between 2 μm and 100 μm; in various further preferred embodiments the thickness is between 2 μm and 75 μm; 2 μm and 50 μm; 5 μm and 100 μm; 5 μm and 75 μm; 2 μm and 50 μm; 10 μm and 100 μm; 10 μm and 75 μm; 10 μm and 50 μm; and 20 μm and 100 μm. In another preferred embodiment of the third aspect, a width of the one or more contact points is between 100 μm and 4 mm; in various further preferred embodiments the thickness is between 100 μm and 3 mm; 100 μm and 2 mm; 100 μm and 1 mm; 250 μm and 4 mm; 500 μm and 4 mm; and 1 mm and 4 mm.

In a further embodiment of the third aspect, the flexible substrate is a plastic substrate or metal substrate. Suitable plastic substrates include, but are not limited to polyethylene naphthalate (PEN), polyethylene terephthalate (PET), polyethersulfone (PES), polyimide, polycarbonate, cyclic olefin copolymer, or mixtures thereof. In another embodiment, the flexible substrate is a metal substrate, and the metal substrate comprises a material selected from the group consisting of INVAR™, KOVAR™, titanium, tantalum, molybdenum, aluchrome, aluminum, stainless steel, or mixtures thereof. The flexible substrate may consist of only a single layer or may comprise multiple layers, for example to provide increased functionality. For example, a moisture barrier layer can be included on either or both sides of the flexible substrate to prevent moisture or oxygen absorption after detachment from the rigid carrier. Other functionalities can also be added to the flexible substrate, as will be understood by those of skill in the art based on the teachings herein. The flexible substrates are preferably thin, ranging from about 1 μm to 500 μm thick or 1 μm to 250 μm. In further preferred embodiments, the flexible substrate is about 10 μm to 250 μm, 10 μm to 200 μm, 10 to 150 μm, 25 μm to 500 μm, 25 μm to 250 μm, 25 μm to 200 μm, 25 μm to 150 μm, 50 μm to 500 μm, 50 μm to 250 μm, 50 μm to 200 μm, or 50 μm to 150 μm thick.

In one preferred embodiment of the third aspect, the rigid carrier comprises a semiconducting material. In another preferred embodiment, the rigid carrier is a semiconductor wafer, such as a silicon wafer (preferably, with a flat surface). In further preferred embodiments, the rigid carrier may comprise or consist of a semiconductor substrate or glass; including but not limited to Si or Si(100). Any semiconductor substrate of the various aspects and embodiments of the invention may independently comprise Si, SiGe, Ge, SiGeSn, GeSn, GaAs, InP, and the like. Preferably, any semiconductor substrate of the various aspects and embodiments of the invention may independently comprise or consist of Si or Si(100). In another preferred embodiment of the third aspect, the rigid carrier has at least one substantially flat surface.

In another preferred embodiment, the rigid support comprises a material including, but not limited to, semiconductor wafer (such as those comprising Si), alumina, a glass, or a material CTE matched to the flexible substrate.

In various further preferred embodiments, a surface of the flexible substrate comprises one or more microelectronic features, including but not limited to thin film transistors, organic light emitting diodes, inorganic light emitting diodes, electrode arrays, field effect transistors, passive structures, or combinations thereof on a surface of the flexible substrate, and display architectures on the flexible substrate.

All embodiments of the first and second aspects of the invention are equally applicable to this third aspect of the invention.

In a fourth aspect, the present invention provides methods for attaching a plastic flexible substrate to a rigid carrier, comprising
(a) depositing a joining material on a surface of the rigid carrier at one or more contact points between the plastic flexible substrate and a rigid carrier;
(b) aligning a metalized surface of the plastic flexible substrate and the joining material on the surface of the rigid carrier surface, wherein the metallization is present on a surface of the plastic flexible substrate at the one or more contact points;
(c) contacting the plastic flexible substrate and the rigid carrier at the one or more contact points; and
(d) exposing the one or more contact points to a temperature of between 219° C. and 1000° C. and under conditions suitable for attaching the plastic flexible substrate and the rigid carrier at the one or more contact points via the joining material.

This aspect provides preferred methods for attaching plastic flexible substrates to rigid carriers. All embodiments of the first, second, and third aspects of the invention are equally applicable to this fourth aspect of the invention.

In various embodiments of the fourth aspect, preferred methods comprise depositing the joining material at one or more contact points between a plastic flexible substrate and a rigid carrier. Such deposition can be by any suitable technique, including but not limited to sputtering, evaporation, screen printing, and ink jet printing. The joining material may be deposited on a surface of the plastic flexible substrate only, the rigid carrier only, or both.

In a preferred embodiment of the fourth aspect, the joining material has a melting temperature of between 219° C. and 1000° C., or between 225° C. and 1000° C., and where the plastic flexible substrate and the rigid carrier have a melting temperature higher that the joining material. In non-limiting preferred embodiments, such joining materials comprise or consist of solders or brazing materials. Non-limiting examples of solders that meet these requirements include, but are not limited to Sn, SnAgCu alloys (such as SnAg(3.5-3.8)Cu(0.7-1)), SnCuSbAg alloys (such as SnCu2.0Sb0.8Ag0.2), and SnSb5 alloys, all of which have melting ranges of 219° C. to 240° C. In a preferred embodiment of the fourth aspect, the joining material is selected from the group consisting of SnAgCu alloys, SnZn alloys, Ni/Ag alloys, Cu/Zn alloys, and Cu/Ag alloys.

In another preferred embodiment of the fourth aspect, the joining material is a brazing materials that meet the preceding requirements including, but are not limited to Ni/Ag, Cu/Zn, Cu/Ag, and ZnAl alloys for metal to metal bonding, or reactive brazing (S-bond),

In one preferred embodiment of the fourth aspect, the plurality of discrete contact points comprises at least 4, 8, 12, 16, 20, 24, 28, 32, 100, 500, 1000, 200, 300, 4000, or more contact points. In another preferred embodiment, the plurality of discrete contact points, comprises at least 4, 8, 12, 16, 20, 24, 28, 32, or more contact points. In these various preferred embodiments, it is preferred that the contact points are along a perimeter of the plastic flexible substrate and the rigid carrier.

In a preferred embodiment of the fourth aspect, a thickness of the one or more contact points is between 2 μm and 100 μm; in various further preferred embodiments the thickness is between 2 μm and 75 μm; 2 μm and 50 μm; 5 μm and 100 μm; 5 μm and 75 μm; 2 μm and 50 μm; 10 μm and 100 μm; 10 μm and 75 μm; 10 μm and 50 μm; and 20 μm and 100 μm. In another preferred embodiment of the fourth aspect, a width of the one or more contact points is between 100 μm and 4 mm; in various further preferred embodiments the thickness is between 100 μm and 3 mm; 100 μm and 2 mm; 100 μm and 1 mm; 250 μm and 4 mm; 500 μm and 4 mm; and 1 mm and 4 mm.

In a preferred embodiment, exposing the one or more contact points to a temperature of between 219° C. and 1000° C., or between 225° C. and 1000° C., is done under vacuum. In various preferred embodiments, the one or more contact points are exposed to temperatures between 250° C. and 1000° C.; 300° C. and 1000° C.; 350° C. and 1000° C.; 400° C. and 1000° C.; 450° C. and 1000° C.; 500° C. and 1000° C.; 550° C. and 1000° C.; 600° C. and 1000° C.; 350° C. and 750° C.; 400° C. and 750° C.; 450° C. and 750° C.; 500° C. and 750° C.; 350° C. and 600° C.; 400° C. and 600° C.; 450° C. and 600° C.; and 500° C. and 600° C. In general, ranges for solders would be between 219° C. and 450° C., or 225° C. and 450° C. and the range for blazing material would be between 450° C. and 1000° C.; as will be understood by those of skill in the art, brazing materials can be used at lower temperatures, and the use of ultrasonic energy can be employed to limit temperature exposure,

For attachment, the plastic flexible substrate and the rigid carrier are aligned and contacted at the one or more contact points; alignment may comprise any suitable technique, including but not limited to lithographic processing, shadow masking, and traditional photolithography and printing. Such contacting can be done using any force suitable for facilitating contact between the plastic flexible substrate and the rigid carrier while providing uniform bonding with low total thickness variation from contact point to contact point. In another embodiment, the conditions comprise applying a force of between 5 and 40 kN to the one or more contact points between the plastic flexible substrate and the rigid carrier prior to or simultaneously with exposing the one or more contact points to a temperature of between 219° C. and 1000° C., or between 225° C. and 1000° C. Such force application can be applied to the assembly as a whole, or be localized to the contact points as suitable for a given application. Force application can be initiated prior to exposing the contact points to high temperature, or can be initiated at the time of high temperature exposure.

In another preferred embodiment, the plastic flexible substrate comprises a material selected from the group consisting of polyethylene naphthalate (PEN), polyethylene terephthalate (PET), polyethersulfone (PES), polyimide, polycarbonate, cyclic olefin copolymer, or mixtures thereof. In another embodiment, the rigid support comprises a material including, but not limited to, semiconductor wafer (such as those comprising Si), alumina, a glass, or a material CTE matched to the plastic flexible substrate. The flexible substrate may consist of only a single layer or may comprise multiple layers, for example to provide increased functionality. For example, a moisture barrier layer can be included on either or both sides of the plastic flexible substrate to prevent moisture or oxygen absorption after detachment from the rigid carrier. Other functionalities can also be added to the plastic flexible substrate, as will be understood by those of skill in the art based on the teachings herein. The plastic flexible substrates are preferably thin, ranging from about 1 μm to 500 μm thick or 1 μm to 250 μm. In further preferred embodiments, the plastic flexible substrate is about 10 μm to 250 μm, 10 μm to 200 μm, 10 to 150 μm, 25 μm to 500 μm, 25 μm to 250 μm, 25 μm to 200 μm, 25 μm to 150 μm, 50 μm to 500 μm, 50 μm to 250 μm, 50 μm to 200 μm, or 50 μm to 150 μm thick.

In one preferred embodiment of the fourth aspect, the rigid carrier comprises a semiconducting material. In another preferred embodiment, the rigid carrier is a semiconductor wafer, such as a silicon wafer (preferably, with a flat surface). In further preferred embodiments, the rigid carrier may comprise or consist of a semiconductor substrate or glass; including but not limited to Si or Si(100). Any semiconductor substrate of the various aspects and embodiments of the invention may independently comprise Si, SiGe, Ge, SiGeSn, GeSn, GaAs, InP, and the like. Preferably, any semiconductor substrate of the various aspects and embodiments of the invention may independently comprise or consist of Si or Si(100). In another preferred embodiment of the fourth aspect, the rigid carrier has at least one substantially flat surface.

Once the plastic flexible substrate is bound to the rigid carrier, any desired microelectronic processing steps can be performed on the plastic flexible substrate, including but not limited to fabricating one or more microelectronic features, including but not limited to thin film transistors, organic light emitting diodes, inorganic light emitting diodes, electrode arrays, field effect transistors, passive structures, or combinations thereof on a surface of the flexible substrate, and display architectures on the plastic flexible substrate.

Once the desired microelectronic processing is complete, the plastic flexible substrate can be detached from the rigid carrier using any suitable technique, such as the use of thermal energy (i.e., laser) and mechanical debonding, and subjected to any further processing steps.

It will be understood that all of the embodiments can be combined with other embodiments unless clearly contradicted by the context. In a further embodiment of all of the above aspects and embodiments, the rigid support comprises a semiconductor wafer, alumina, a glass, or a material CTE matched to the flexible substrate. A “CTE matched material” as used herein means a material which has a coefficient of thermal expansion (CTE) which differs from the CTE of the referenced material by less than about 20%. Preferably, the CTEs differ by less than about 10%, 5%, 3%, or 1%.

### EXAMPLES

Example of Process 1: Metal foil bonded to ceramic/glass carrier
1. Deposit (discrete or continuous) brazing material on carrier substrate (glass, alumina, etc.)
2. Align metal foil substrate with carrier.
3. Elevate temperature of components (preferably in vacuum) to the joining temperature
4. Bring metal foil substrate and carrier in contact
5. Apply force to the contact to provide a uniform bond with low total thickness variation.
6. Cool to ambient
7. Perform TFT or other microelectronic processing.
8. Debond flexible substrate from carrier

Example of Process 2: Polyimide foil bonded to ceramic/glass carrier
1. Metallize backside of polyimide with “bondable” material such as Ag or Al via sputtering or evaporation.
2. Deposit (discrete or continuous) brazing material on carrier substrate (glass, alumina, etc.)
3. Align metallization on backside of polyimide with brazing material on carrier.
4. Elevate temperature of components (preferably in vacuum) to the joining temperature
5. Bring polyimide substrate and carrier in contact
6. Apply force to the contact to provide a uniform bond with low total thickness variation.
7. Cool to ambient
8. Perform TFT or other microelectronic processing.
9. Debond flexible substrate from carrier

Various changes and modifications to the methods and embodiments herein chosen for purposes of illustration will readily occur to those skilled in the art. To the extent that such modifications and variations do not depart from the spirit of the invention, they are intended to be included within the scope thereof which is assessed only by a fair interpretation of the following claims.

We claim:

1. A method for attaching a flexible substrate to a rigid carrier, comprising
(a) depositing a joining material at one or more contact points between a flexible substrate and a rigid carrier;
(b) contacting the flexible substrate and the rigid carrier at the one or more contact points; and
(c) exposing the one or more contact points to a temperature of between 219° C. and 1000° C. and under conditions suitable for attaching the flexible substrate and the rigid carrier at the one or more contact points via the joining material.

2. The method of claim 1 wherein the joining material comprises soldering or brazing material.

3. (canceled)

4. The method of claim 1 wherein the one or more contact points have a thickness of between 2 μm and 100 μm.

5. The method of claim 1 wherein the one or more contact points have a width of between 100 μm and 4 mm.

6. (canceled)

7. The method of claim 1 wherein the conditions comprise applying a force of between 5 and 40 kN to the one or more contact points between the flexible substrate and the rigid carrier prior to or simultaneously with exposing the one or more contact points to a temperature of between 219° C. and 1000° C.

8-10. (canceled)

11. The method of claim 1 wherein the flexible substrate is a plastic substrate or metal substrate.

12-13. (canceled)

14. The method of claim 1 wherein the rigid support comprises a semiconductor wafer, alumina, a glass, or a material coefficient of thermal expansion (CTE) matched to the flexible substrate.

15-17. (canceled)

18. An assembly comprising:
(a) a flexible substrate;
(b) a rigid carrier; and
(c) a plurality of discrete contact points between the flexible substrate and the rigid carrier,
wherein the contact points comprise a joining material with a melting temperature between 219° C. and 1000° C., and wherein the flexible substrate and the rigid carrier have a melting temperature greater that the melting temperature of the joining material.

19. (canceled)

20. The assembly of claim 18 wherein the plurality of discrete contact points have a thickness of between 2 μm and 100 μm.

21. The assembly of claim 18 wherein the plurality of discrete contact points have a width of between 100 μm and 4 mm.

22. The assembly of claim 18 wherein the joining material is selected from the group consisting of SnAgCu alloys, SnZn alloys, Ni/Ag alloys, Cu/Zn alloys, SnCuSb Ag alloys, ZnAl alloys, and Cu/Ag alloys.

23. The assembly of claim 18 wherein the flexible substrate is a plastic substrate or metal substrate.

24-25. (canceled)

26. The assembly of claim 18 wherein the rigid support comprises a semiconductor wafer, alumina, a glass, or a material CTE matched to the flexible substrate.

27. (canceled)

28. The assembly of claim 18 wherein the flexible substrate comprises at least one electronic component and/or circuit on a surface of the flexible substrate.

29. The assembly of claim 18 further comprising a display architecture on the flexible substrate.

30. (canceled)

31. An assembly, comprising
(a) a flexible substrate;
(b) a rigid carrier; and
(c) a joining material at one or more contact points between the flexible substrate and the rigid carrier,
wherein the joining material has a melting temperature between 219° C. and 1000° C., and wherein the flexible substrate and the rigid carrier have a melting temperature greater that the melting temperature of the joining material, and wherein the assembly has a bow of less than 150 μm.

32. (canceled)

33. The assembly of claim 31 wherein the one or more contact points have a thickness of between 2 μm and 100 μm.

34. The assembly of claim 31 wherein the one or more contact points has a width of between 100 μm and 4 mm.

35. The assembly of claim 31 wherein the joining material is selected from the group consisting of SnAgCu alloys, SnZn alloys, Ni/Ag alloys, Cu/Zn alloys, SnCuSb Ag alloys, ZnAl alloys, and Cu/Ag alloys.

36. The assembly of claim 31 wherein the flexible substrate is a plastic substrate or metal substrate.

37-38. (canceled)

39. The assembly of claim 31 wherein the rigid support comprises a semiconductor wafer, alumina, a glass, or a material coefficient of thermal expansion (CTE) matched to the flexible substrate.

40-42. (canceled)

43. The assembly of claim 31 further comprising one or more thin film transistors, organic light emitting diodes, inorganic light emitting diodes, electrode arrays, field effect transistors, passive structures, photovoltaic devices, or combinations thereof on a surface of the flexible substrate.

44. A method for attaching a plastic flexible substrate to a rigid carrier, comprising
(a) depositing a joining material on a surface of the rigid carrier at one or more contact points between the plastic flexible substrate and a rigid carrier;
(b) aligning a metalized surface of the plastic flexible substrate and the joining material on the surface of the rigid carrier surface, wherein the metallization is present on a surface of the flexible substrate at the one or more contact points;
(c) contacting the plastic flexible substrate and the rigid carrier at the one or more contact points; and
(d) exposing the one or more contact points to a temperature of between 219° C. and 1000° C. and under conditions suitable for attaching the plastic flexible substrate and the rigid carrier at the one or more contact points via the joining material.

45. The method of claim 44 wherein the joining material comprises soldering or brazing material.

46. (canceled)

47. The method of claim 44 wherein the one or more contact points have a thickness of between 2 μm and 100 μm.

48. The method of claim 44 wherein the one or more contact points have a width of between 100 μm and 4 mm.

49. The method of claim 44 where exposing the one or more contact points to a temperature of between 219° C. and 1000° C. is done under vacuum.

50. The method of claim 44 wherein the conditions comprise applying a force of between 5 and 40 kN to the one or more contact points between the plastic flexible substrate and the rigid carrier prior to or simultaneously with exposing the one or more contact points to a temperature of between 219° C. and 1000° C.

51-54. (canceled)

55. The method of claim 44 wherein the rigid support comprises a semiconductor wafer, alumina, a glass, or a material coefficient of thermal expansion (CTE) matched to the plastic flexible substrate.

56-58. (canceled)
